(19) United States
(12) Patent Application Publication
(10) Pub. No.: US 2026/0138426 A1
(43) Pub. Date: May 21, 2026

(54) VEHICLE WITH MANUALLY CONFIGURABLE BI-DIRECTIONAL ROOF

(71) Applicant: Ford Global Technologies, LLC, Dearborn, MI (US)

(72) Inventors: Michael John Harmon, Northville, MI (US); Robert J. Gelardi, Plymouth, MI (US); Darren Luke, West Bloomfield, MI (US); Ricardo Haruo Sugimoto, Camaçari (BR); Daniel J. Kangas, Livonia, MI (US); Justin D. Sorum, Royal Oak, MI (US); Abbas Ghamlouche, Dearborn, MI (US)

(21) Appl. No.: 18/950,826

(22) Filed: Nov. 18, 2024

(51) Int. Cl. B60J 7/06

(52) U.S. Cl. CPC B60J 7/061

(57) ABSTRACT

A motor vehicle may include a roof including a roof opening. The motor vehicle may include a panel manually configurable between a fully closed position in which the panel fully covers the roof opening and a plurality of open positions in which at least a portion of the roof opening is uncovered by the panel. Further, the panel may be moveable from the fully closed position to a first open position by movement of the panel in a first direction, and the panel may also be moveable from the fully closed position to a second open position by movement of the panel in a second direction opposite the first direction.

### TECHNICAL FIELD

This disclosure relates to a motor vehicle including a manually configurable bi-directional roof. In particular, the roof is able to be opened manually by moving a panel in either a first direction, a second direction opposite the first direction, or both.

### BACKGROUND

Motor vehicles, including sport utility vehicles (SUVs), are known to include roofs that incorporate roof openings. These roof openings are configured be selectively uncovered, enabling passengers to enjoy the air and natural elements while maintaining the option for full coverage when needed.

### SUMMARY

In some aspects, the techniques described herein relate to a motor vehicle, including: a roof including a roof opening; and a panel manually configurable between a fully closed position in which the panel fully covers the roof opening and a plurality of open positions in which at least a portion of the roof opening is uncovered by the panel, wherein the panel is moveable from the fully closed position to a first open position by movement of the panel in a first direction, and wherein the panel is moveable from the fully closed position to a second open position by movement of the panel in a second direction opposite the first direction.

In some aspects, the techniques described herein relate to a motor vehicle, wherein: when the panel is in the first open position, a first portion of the roof opening on a side of the panel opposite the first direction is uncovered by the panel, and when the panel is in the second open position, a second portion of the roof opening on a side of the panel opposite the second direction is uncovered by the panel.

In some aspects, the techniques described herein relate to a motor vehicle, wherein the panel is configurable such that both the first portion of the roof opening and the second portion of the roof opening are simultaneously uncovered by the panel.

In some aspects, the techniques described herein relate to a motor vehicle, wherein: the panel includes at least one clamp, the motor vehicle further includes a plurality of attachment points arranged about the roof opening, the at least one clamp is configured to selectively attach and detach from the plurality of attachment points to selectively configure the panel between the fully closed and at least one open positions.

In some aspects, the techniques described herein relate to a motor vehicle, wherein: the panel includes a first end, a second end opposite the first end, a first side extending between the first and second ends, and a second side opposite the first side and extending between the first and second ends, and the panel includes at least one clamp adjacent the first end, and the panel includes at least one clamp adjacent the second end.

In some aspects, the techniques described herein relate to a motor vehicle, wherein: the panel includes a first clamp and a second clamp adjacent the first end, and the panel includes a third clamp and a fourth clamp adjacent the second end.

In some aspects, the techniques described herein relate to a motor vehicle, wherein: the roof opening includes a first end, a second end opposite the first end, a first side extending between the first and second ends, and a second side opposite the first side and extending between the first and second ends, and first and second end attachment points are arranged adjacent the first end of the roof opening, third and fourth end attachment points are arranged adjacent the second end of the roof opening, the first and second end attachment points are configured to selectively interface with the first and second clamps, respectively, and the third and fourth end attachment points are configured to selectively interface with the third and fourth clamps, respectively.

In some aspects, the techniques described herein relate to a motor vehicle, wherein: a plurality of first side attachment points are spaced-apart from one another along the first side of the roof opening, a plurality of second side attachment points are spaced-apart from one another along the second side of the roof opening, the first side attachment points are configured to selectively interface with the first and third clamps, and the second side attachment points are configured to selectively interface with the second and fourth clamps.

In some aspects, the techniques described herein relate to a motor vehicle, wherein the first, second, third, and fourth end attachment points are vertically spaced-apart from each of the first and second side attachment points.

In some aspects, the techniques described herein relate to a motor vehicle, wherein the first, second, third, and fourth end attachment points are vertically below each of the first and second side attachment points.

In some aspects, the techniques described herein relate to a motor vehicle, wherein: the at least one clamp includes a lever, rotation of the lever selectively permits a user to bring the clamp into or out of engagement with one of the attachment points.

In some aspects, the techniques described herein relate to a motor vehicle, wherein the plurality of attachment points are configured such that each attachment point establishes at least part of a closed loop configured to facilitate selective engagement with the at least one clamp.

In some aspects, the techniques described herein relate to a motor vehicle, wherein each of the plurality of attachment points is provided by a U-shaped bracket projecting from a portion of the motor vehicle defining the roof opening.

In some aspects, the techniques described herein relate to a motor vehicle, wherein: the panel includes a first end, a second end opposite the first end, a first side extending between the first and second ends, and a second side opposite the first side and extending between the first and second ends, the roof opening includes a first end, a second end opposite the first end, a first side extending between the first and second ends, and a second side opposite the first side and extending between the first and second ends, the panel includes a plurality of pins projecting from the first side and the second side, a first track adjacent the first side of the roof opening receives the pins projecting from the first side of the panel, and a second track adjacent the second side of the roof opening receives the pins projecting from the second side of the panel.

In some aspects, the techniques described herein relate to a motor vehicle, further including: a beam projecting across the roof opening, a first portion of the panel is on a side of the beam opposite the first direction, and a second portion of the panel is on a side of the beam opposite the second direction.

In some aspects, the techniques described herein relate to a motor vehicle, wherein the first and second portions of the panel are independently moveable.

In some aspects, the techniques described herein relate to a motor vehicle, further including: a roof rack including cross-bars vertically overlapping the roof opening, wherein the panel is configurable between the fully closed position and the at least one open position without interfering with the roof rack.

In some aspects, the techniques described herein relate to a method, including: manually moving a panel from a fully closed position in which the panel fully covers a roof opening in a roof of a motor vehicle to a first open position by moving the panel in a first direction; manually moving the panel from the first open position to the fully closed position; and manually moving the panel from the fully closed position to a second open position by movement of the panel in a second direction opposite the first direction.

In some aspects, the techniques described herein relate to a method, further including: before any of the moving steps, detaching the panel from one of a plurality of attachment points by rotating at least one clamp of the panel, wherein the plurality of attachment points are spaced-apart from one another about the roof opening.

In some aspects, the techniques described herein relate to a method, wherein: the step of moving the panel to the first open position includes moving a first portion of the panel relative to a beam projecting across the roof opening, and the step of moving the panel to the second open position includes moving a second portion of the panel relative to the beam.

### BRIEF DESCRIPTION OF THE DRAWINGS

FIG. 1 illustrates a front perspective view of an example motor vehicle, which in this example is an SUV.

FIG. 2 is a top perspective view of a roof of the motor vehicle.

FIG. 3 is a view similar to FIG. 2, with a panel in a fully closed position relative to a roof opening.

FIG. 4 is a view, from an interior of the motor vehicle, of the panel in the configuration of FIG. 3.

FIG. 5 illustrates an example attachment point.

FIG. 6 illustrates an example clamp.

FIG. 7 illustrates, without the remainder of the motor vehicle, first and second tracks relative to the panel.

FIG. 8 is a view similar to FIG. 2, with the panel in a first example open position.

FIG. 9 is a view similar to FIG. 2, with the panel in a second example open position.

FIG. 10 is a view similar to FIG. 2, with the panel in a third example open position.

FIG. 11 is a view similar to FIG. 2, with the panel in a fourth example open position.

FIG. 12 is a view of the panel in a fully closed position relative to a roof rack.

FIG. 13 is a view of the panel in an example open position relative to the roof rack.

FIG. 14 illustrates another configuration of the panel including a beam.

FIG. 15 is a perspective view of a roof including the configuration of Figure in a fully closed position.

FIG. 16 is a perspective view of a roof including the configuration of Figure in an example open position.

### DETAILED DESCRIPTION

This disclosure relates to a motor vehicle including a manually configurable bi-directional roof. In particular, the roof is able to be opened manually by moving a panel in either a first direction, a second direction opposite the first direction, or both. Among other benefits, this disclosure allows a user to arrange the roof in a custom configuration to expose a desired portion of the passenger compartment to the elements. Further, the roof is configurable by hand, without the use of electrically powered equipment or tools.

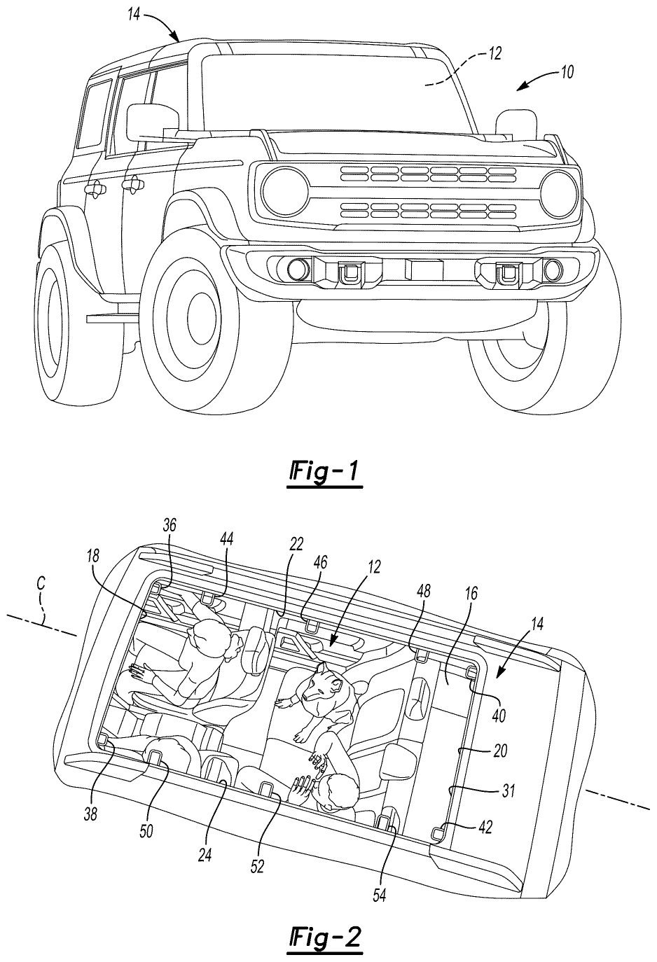

FIG. 1 illustrates a motor vehicle 10 (“vehicle 10”), which in this example is a sport utility vehicle (SUV). While an SUV is shown, the vehicle 10 could be another type of vehicle.

The vehicle 10 includes a passenger compartment, or passenger cabin, 12. A roof 14 is vertically above the passenger compartment 12. The roof 14 is defined by a body and/or a frame of the vehicle 10, and is generally configured to cover the passenger compartment 12 to protect the occupants from the weather and other elements.

With reference to FIG. 2, the roof 14 includes a roof opening 16. The roof opening 16 is defined between a first end 18, a second end 20 opposite the first end 18, a first side 22 extending between the first and second ends 18, 20, and a second side 24 opposite the first side 22 and extending between the first and second ends 18, 20. The roof opening 16 is substantially rectangular in this example. The roof opening 16 exhibits an area within a range of 65-85% of the area of the roof 14 (inclusive of the roof opening 16). In FIG. 2, the roof opening 16 is uncovered for ease of reference. An elastomeric seal 31 may extend about the entire perimeter of the roof opening 16. In this disclosure, a panel 26 is configured to selectively cover at least a portion of the roof opening 16.

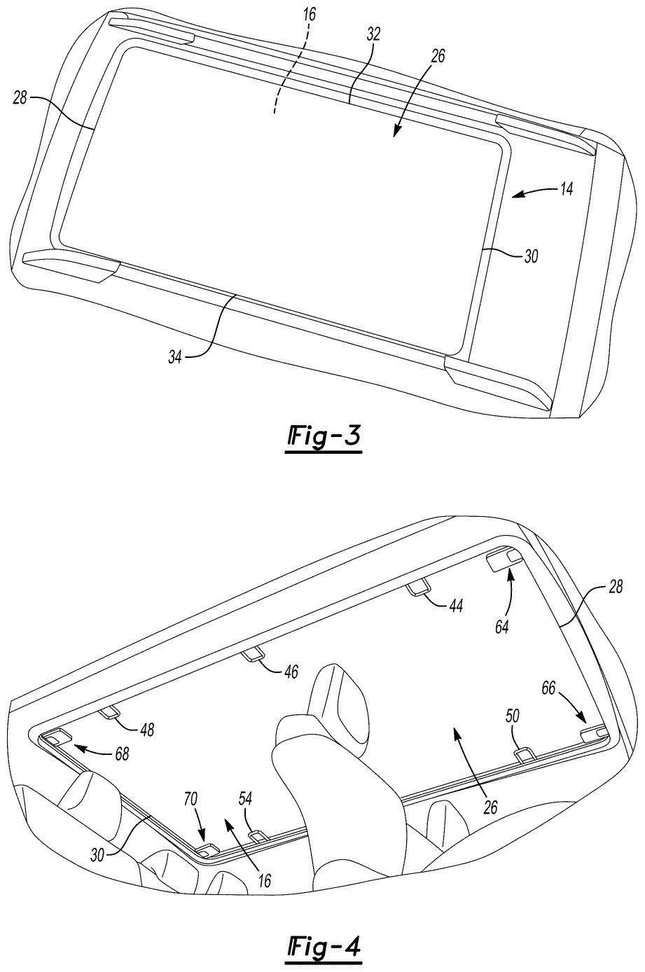

FIGS. 3 and 4 illustrate the panel 26 arranged relative to the roof opening 16 and in a fully closed position, in which the panel 26 fully covers the roof opening 16. The panel 26 may be made of a flexible, waterproof material, such as canvas, leather, etc. The panel 26 is sized and shaped to correspond to a size and shape of the roof opening 16, such that the panel 26 can fully cover the roof opening 16.

The panel 26 includes a first end 28, a second end 30 opposite the first end 28, a first side 32 extending between the first and second ends 28, 30, and a second side 34 opposite the first side 32 and extending between the first and second ends 28, 30.

The panel 26, in this disclosure, includes at least one clamp, and in a particular example a plurality of clamps, configured to selectively attach and detach from a plurality of attachment points arranged relative to the roof opening 16. Depending on which attachment points the panel 26 is attached to, the panel 26 will take on a unique configuration and uncover different portions of the passenger compartment 12. A user is able to configure the clamps relative to the plurality of attachment points to selectively configure the panel 26 between the fully closed position and at least one open position.

With reference to FIG. 2, first and second end attachment points 36, 38 are arranged adjacent the first end 18 of the roof opening 16. Further, third and fourth attachment end points 40, 42 are arranged adjacent the second end 20 of the roof opening 16. A plurality of first side attachment points 44, 46, 48 are spaced-apart from one another along the first side 22 of the roof opening 16, and a plurality of second side attachment points 50, 52, 54 are spaced-apart from one another along the second side 24 of the roof opening 16. While two end attachment points are shown relative to the first and second ends 18, 20, this disclosure extends to configurations with a different quantity of end attachment points. Further, while three side attachments points are shown relative to the first side 22 and the second side 24, this disclosure extends to configurations with a different quantity of side attachment points.

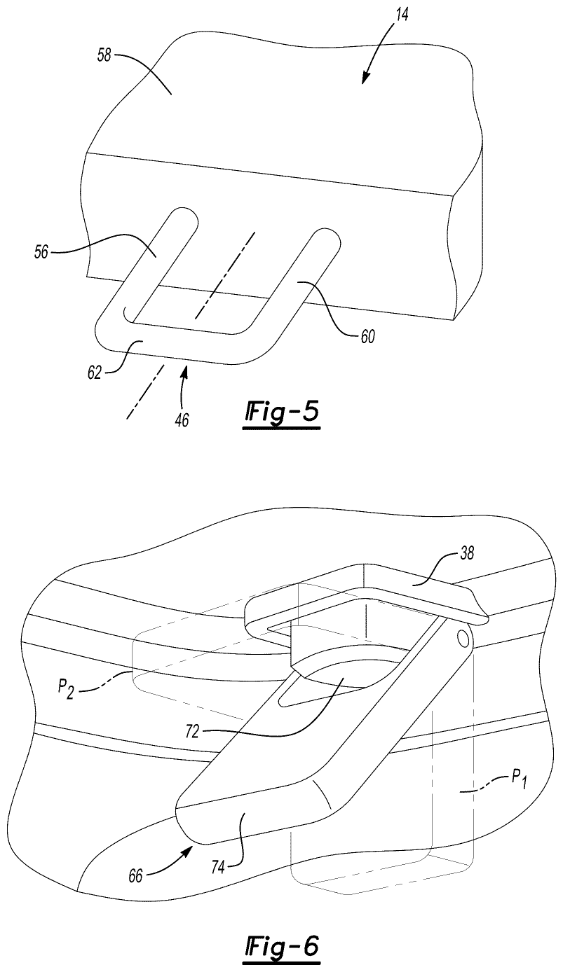

Each of the attachment points 36, 38, 40, 42, 44, 46, 48, 50, 52, 54 is provided by a U-shaped bracket, in this example. With reference to FIG. 5, the attachment point 46 is shown in detail. The attachment point 46 includes a first leg 56 projecting inwardly from a portion 58 of the roof 14 establishing a boundary of the roof opening 16, and a second leg 60 projecting from the portion 58. The first and second legs 56, 60 are substantially parallel to one another. A third leg 62 extends between the first and second legs 56, 60 and is substantially perpendicular to the first and second legs 56, 60. Together, the first leg 56, second leg 60, third leg 62, and the portion 58 define a closed-loop. The first and second legs 56, 60 extend substantially perpendicular to the centerline C of the vehicle, and third leg 62 extends substantially parallel to centerline C.

Side attachment points 44 and 48 are configured substantially similar to attachment point 46. Side attachment points 50, 52, 54 are configured substantially similar to the side attachment points 44, 46, 48, reflected about centerline C. End attachment points 36, 38, 40, 42 are configured substantially similar to the side attachment points, but with the first and second legs (i.e., legs corresponding to legs 56, 60) arranged substantially parallel to the centerline C. While a particular attachment point arrangement has been shown and described, this disclosure extends to other configurations for the attachment points.

Attachment points 36 and 38, 44 and 50, 46 and 52, 48 and 54, and 40 and 42 are aligned with one another relative to the centerline C. Further, attachment points 36 and 40, and 38 and 42 are aligned with one another in a direction perpendicular to the centerline C.

With reference to FIG. 4, in this example, the panel 26 includes at least one clamp adjacent the first end 28, and the panel 26 includes at least one clamp adjacent the second end 30. In particular, in this example, the panel 26 includes a first clamp 64 and a second clamp 66 adjacent the first end 28. The panel further includes a third clamp 68 and a fourth clamp 70 adjacent the second end 30.

The first and second clamps 64, 66 are configured to selectively interface with the first and second end attachment points 36, 38, respectively. The third and fourth clamps 68, 70 are configured to selectively interface with the third and fourth end attachment points 40, 42, respectively. Further, the first and third clamps 64, 68 are configured to selectively interface with the side attachment points 44, 46, 48, and the second and fourth clamps 66, 70 are configured to selectively interface with the side attachment points 50, 52, 54.

In an example of this disclosure, the first, second, third, and fourth end attachment points 36, 38, 40, 42 are vertically spaced-apart from each of the side attachment points 44, 46, 48, 50, 52, 54 such that, when the panel 26 is in the fully closed position, additional tension is placed on the panel 26, which urges the panel 26 into engagement with seal 31, which in turn assists the panel 26 in preventing ingress of water, dust, dirt, snow, etc., into the passenger compartment 12 relative to the roof opening 16. In a specific example of this disclosure, the first, second, third, and fourth end attachment points 36, 38, 40, 42 are vertically below each of the side attachment points 44, 46, 48, 50, 52, 54.

An example clamp is shown in more detail in FIG. 6. In FIG. 6, the clamp 66 is shown relative to the end attachment point 38. The clamp 66 includes a base 72 and a lever 74 rotatable relative to the base 72. The base 72 is sized and shaped to fit within the closed-loop defined by the attachment point 38. The lever 74 is rotatable between a first position P1 and a second position P2. The lever 74 is rotatable by substantially 90° when moving between the first and second positions P1, P2. The lever 74 is shown in an intermediate position between the first and second positions P1, P2 in FIG. 6. In the first position P1, a user may selectively disengage the clamp 66 from the end attachment point 38 by lifting the base 72 and lever 74 vertically out of engagement with the end attachment point 38. In the second position P2, the lever 74 is held, such as under the force of a cam surface of the lever 74 and/or the base 72, in a position substantially parallel to the legs of the end attachment point 38 to prevent detachment of the clamp 66 from the end attachment point 38. While a particular arrangement of clamps and attachment points has been described, the clamps could attach and detach from the attachment points in another manner, however.

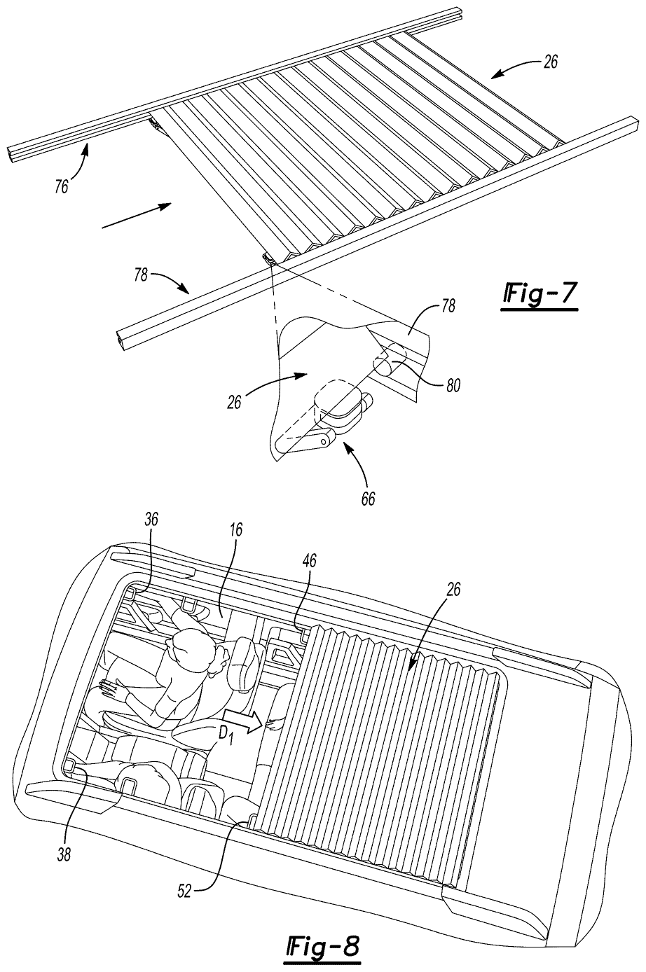

When at least some of the clamps 64, 66, 68, 70 are detached from the attachment points, the panel 26 is slidable. In this example, the vehicle 10 includes a first track 76 and a second track 78, as shown in FIG. 7. The first track 76 may be attached to, or integrated into, the first side 22 of the roof opening 16, and the second track 78 may be attached to, or integrated into, the second side 24 of the roof opening 16. The first and second tracks 76, 78 may be substantially U-shaped in cross-section, open facing toward the panel 26. The panel 26 includes a plurality of pins 80, in this example, projecting from the first and second sides 32, 34 of the panel 26 and into the respective first and second tracks 76, 78. The pins 80 may include rolling elements, such as wheels. The pins 80 may be bearing pins. As the panel 26 slides, the panel 26 may naturally fold between adjacent pins 80. Such folding of the panel 26 may be said to be accordion-style. The panel 26 may include internal structural members designed to facilitate an accordion-style folding of the panel 26.

The panel 26 is manually configurable between the fully closed position of FIG. 3, in which the panel 26 fully covers the roof opening 16, and a plurality of open positions in which at least a portion of the roof opening 16 is uncovered by the panel 26. In this disclosure, reference to the panel 26 being manually configurable means the panel 26 is able to be configured between the fully closed and various open positions without powered electrical components, such as motors, drives, actuators, etc., and further refers to the panel 26 being configurable by a user by hand and without the use of tools such as screwdrivers, drills, wrenches, etc.

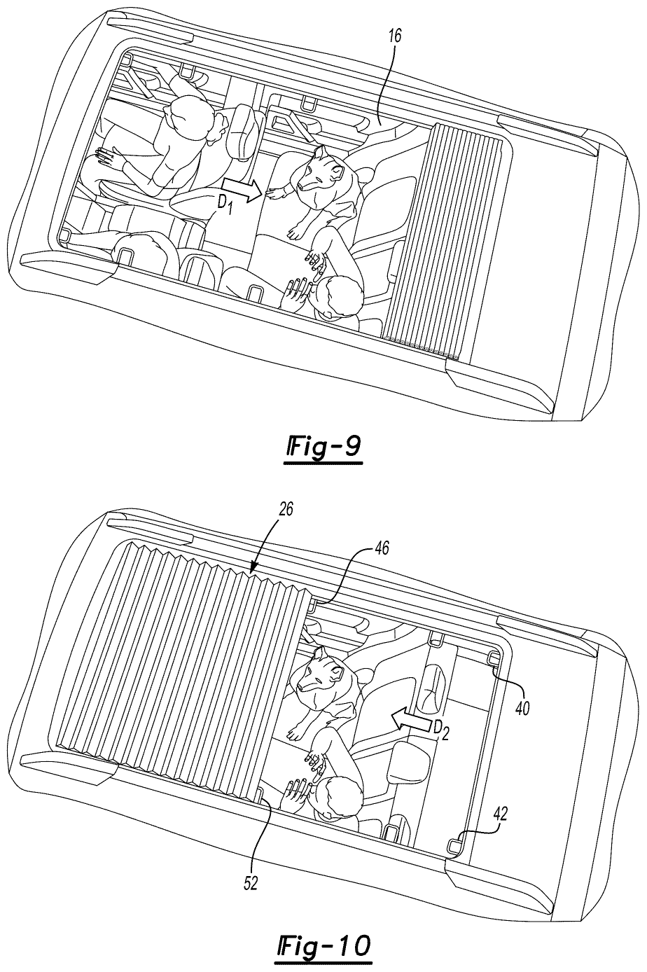

Example open positions of the panel 26 will now be described. FIG. 8 represents a configuration in which the panel 26 was moved from the fully closed position, such as by detaching clamps 64, 66 from attachment points 36, 38, to a first open position by movement of the panel 26 in a first direction D1. The first direction D1 is a rearward direction. After the panel 26 has been slid in direction D1, a portion of the roof opening 16 on a side of the panel 26 opposite the first direction D1 is uncovered by the panel 26. In FIG. 8, the panel 26 does not cover those occupants in the front of the vehicle 10. In FIG. 8, clamps 64, 66 are attached to attachment points 46, 52. Further, clamps 68, 70 are attached to attachment points 40, 42. FIG. 9 represents another configuration in which continued movement of the panel 26 in direction D1 uncovers more of the roof opening 16. In FIG. 9, clamps 64, 66 are attached to attachment points 48, 54. In FIG. 9, the panel 26 does not cover those occupants in the front or the second row of the vehicle 10.

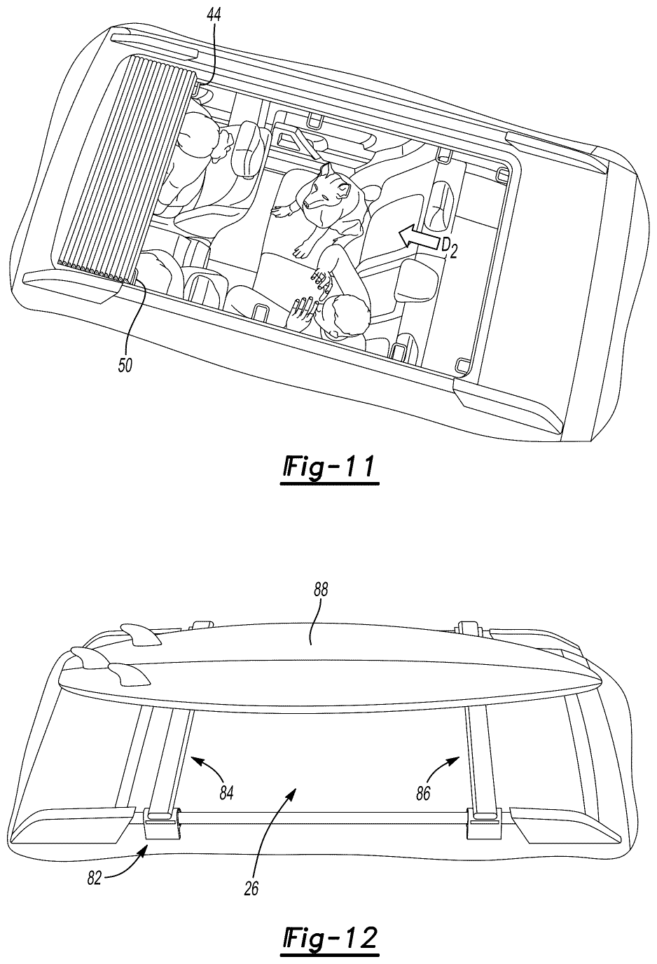

FIG. 10 represents a configuration in which the panel 26 was moved from the fully closed position, such as by detaching clamps 68, 70 from attachment points 40, 42, to a second open position by movement of the panel 26 in a second direction D2 opposite the first direction D1. After the panel 26 has been slid in direction D2, a portion of the roof opening 16 on a side of the panel 26 opposite the second direction D2 is uncovered by the panel 26. In FIG. 10, clamps 68, 70 are attached to attachment points 46, 52. Further, clamps 64, 66 are attached to attachment points 36, 38. In FIG. 10, the panel 26 does not cover those occupants in the second row of the vehicle 10. FIG. 11 represents another configuration in which continued movement of the panel 26 in direction D2 uncovers more of the roof opening 16 than in the configuration of FIG. 10. In FIG. 11, clamps 68, 70 are attached to attachment points 44, 50. In FIG. 11, the panel 26 does not cover those occupants in the second row of the vehicle 10, and only partially covers those occupants in the front row.

The panel 26 may be configurable such that portions of the roof opening 16 on both sides of the panel 26 are uncovered. For example, the clamps 64, 66 can be attached to attachment points 44, 50 while the clamps 68, 70 can be attached to attachment points 48, 54.

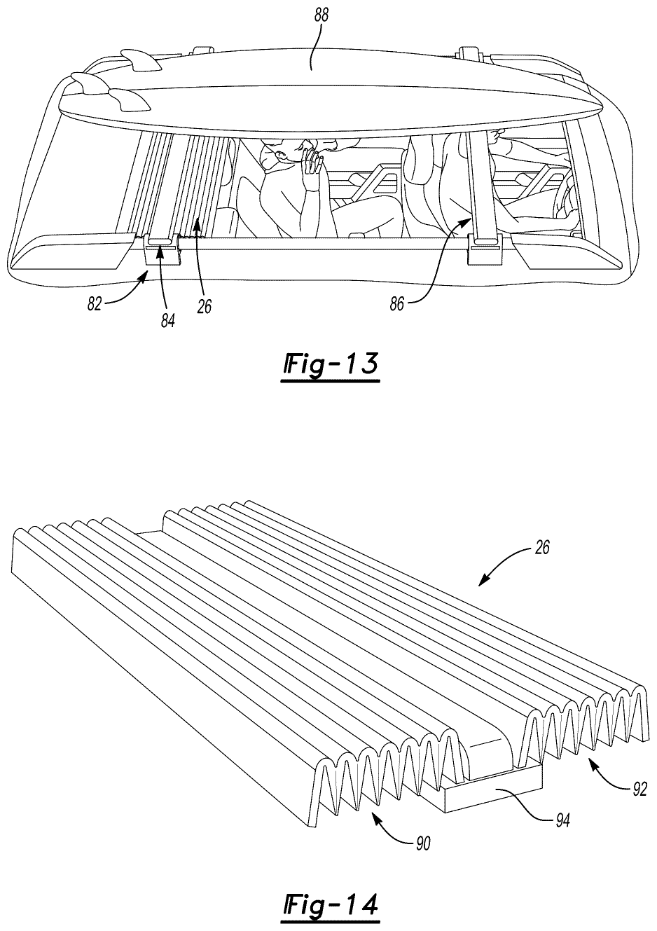

The arrangement of the panel 26 is such that the panel 26 may be configurable between the fully closed position (FIG. 12) and the at least one open position (FIG. 13) without interfering with a roof rack 82, even when the roof rack 82 includes cross-bars 84, 86, which may or may not support gear 88 thereon, vertically overlapping the roof opening 16.

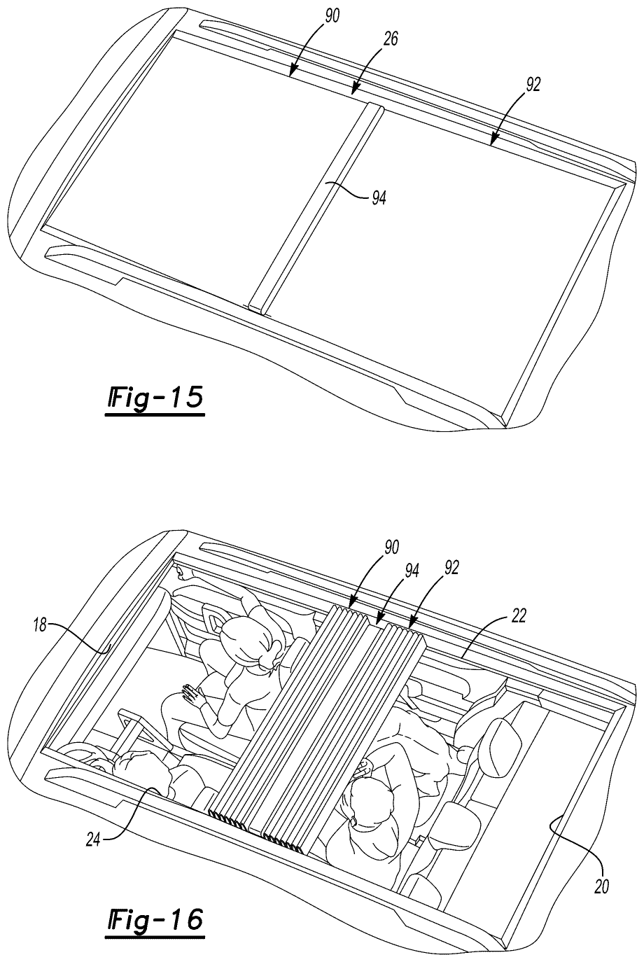

In another configuration of the panel 26, shown between FIGS. 14-16, the panel 26 includes first and second portions 90, 92, which are independently moveable relative to one another relative to a beam 94 extending across the roof opening 16, from first side 22 to second side 24. The beam 94 may be integrated into the roof 14, or be provided by the frame and/or body of the vehicle 10, or be provided by a separate structure attached to the roof 14. The first portion 90 is rigidly fixed to the beam 94 at one end, and is slidable relative to the first end 18 of the roof opening 16. The second portion 92 is rigidly fixed to the beam 94 at one end, and is slidable relative to the second end 20 of the roof opening 16. The first and second portions 90, 92 may include pins configured to slide within tracks, and may include clamps configured to selectively attach to end and side attachment points, as in the above embodiment.

It should be understood that terms such as “about,” “substantially,” and “generally” are not intended to be boundaryless terms, and should be interpreted consistent with the way one skilled in the art would interpret those terms. Further, directional terms such as “upper,” “forward,” “rearward,” “upward,” “downward,” “vertical,” “horizontal,” “below,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a roof including a roof opening; and
a panel manually configurable between a fully closed position in which the panel fully covers the roof opening and a plurality of open positions in which at least a portion of the roof opening is uncovered by the panel, wherein the panel is moveable from the fully closed position to a first open position by movement of the panel in a first direction, and wherein the panel is moveable from the fully closed position to a second open position by movement of the panel in a second direction opposite the first direction.

2. The motor vehicle as recited in claim 1, wherein:
when the panel is in the first open position, a first portion of the roof opening on a side of the panel opposite the first direction is uncovered by the panel, and
when the panel is in the second open position, a second portion of the roof opening on a side of the panel opposite the second direction is uncovered by the panel.

3. The motor vehicle as recited in claim 2, wherein the panel is configurable such that both the first portion of the roof opening and the second portion of the roof opening are simultaneously uncovered by the panel.

4. The motor vehicle as recited in claim 1, wherein:
the panel includes at least one clamp,
the motor vehicle further comprises a plurality of attachment points arranged about the roof opening,
the at least one clamp is configured to selectively attach and detach from the plurality of attachment points to selectively configure the panel between the fully closed and at least one open positions.

5. The motor vehicle as recited in claim 4, wherein:
the panel includes a first end, a second end opposite the first end, a first side extending between the first and second ends, and a second side opposite the first side and extending between the first and second ends, and
the panel includes at least one clamp adjacent the first end, and
the panel includes at least one clamp adjacent the second end.

6. The motor vehicle as recited in claim 5, wherein:
the panel includes a first clamp and a second clamp adjacent the first end, and
the panel includes a third clamp and a fourth clamp adjacent the second end.

7. The motor vehicle as recited in claim 6, wherein:
the roof opening includes a first end, a second end opposite the first end, a first side extending between the first and second ends, and a second side opposite the first side and extending between the first and second ends, and
first and second end attachment points are arranged adjacent the first end of the roof opening,
third and fourth end attachment points are arranged adjacent the second end of the roof opening,
the first and second end attachment points are configured to selectively interface with the first and second clamps, respectively, and
the third and fourth end attachment points are configured to selectively interface with the third and fourth clamps, respectively.

8. The motor vehicle as recited in claim 7, wherein:
a plurality of first side attachment points are spaced-apart from one another along the first side of the roof opening,
a plurality of second side attachment points are spaced-apart from one another along the second side of the roof opening,
the first side attachment points are configured to selectively interface with the first and third clamps, and
the second side attachment points are configured to selectively interface with the second and fourth clamps.

9. The motor vehicle as recited in claim 8, wherein the first, second, third, and fourth end attachment points are vertically spaced-apart from each of the first and second side attachment points.

10. The motor vehicle as recited in claim 9, wherein the first, second, third, and fourth end attachment points are vertically below each of the first and second side attachment points.

11. The motor vehicle as recited in claim 4, wherein:
the at least one clamp includes a lever,
rotation of the lever selectively permits a user to bring the clamp into or out of engagement with one of the attachment points.

12. The motor vehicle as recited in claim 4, wherein the plurality of attachment points are configured such that each attachment point establishes at least part of a closed loop configured to facilitate selective engagement with the at least one clamp.

13. The motor vehicle as recited in claim 12, wherein each of the plurality of attachment points is provided by a U-shaped bracket projecting from a portion of the motor vehicle defining the roof opening.

14. The motor vehicle as recited in claim 1, wherein:
the panel includes a first end, a second end opposite the first end, a first side extending between the first and second ends, and a second side opposite the first side and extending between the first and second ends,
the roof opening includes a first end, a second end opposite the first end, a first side extending between the first and second ends, and a second side opposite the first side and extending between the first and second ends,
the panel includes a plurality of pins projecting from the first side and the second side,
a first track adjacent the first side of the roof opening receives the pins projecting from the first side of the panel, and
a second track adjacent the second side of the roof opening receives the pins projecting from the second side of the panel.

15. The motor vehicle as recited in claim 1, further comprising:
a beam projecting across the roof opening,
a first portion of the panel is on a side of the beam opposite the first direction, and
a second portion of the panel is on a side of the beam opposite the second direction.

16. The motor vehicle as recited in claim 15, wherein the first and second portions of the panel are independently moveable.

17. The motor vehicle as recited in claim 1, further comprising:
a roof rack including cross-bars vertically overlapping the roof opening, wherein the panel is configurable between the fully closed position and the at least one open position without interfering with the roof rack.

18. A method, comprising:
manually moving a panel from a fully closed position in which the panel fully covers a roof opening in a roof of a motor vehicle to a first open position by moving the panel in a first direction;
manually moving the panel from the first open position to the fully closed position; and
manually moving the panel from the fully closed position to a second open position by movement of the panel in a second direction opposite the first direction.

19. The method as recited in claim 18, further comprising:
before any of the moving steps, detaching the panel from one of a plurality of attachment points by rotating at least one clamp of the panel, wherein the plurality of attachment points are spaced-apart from one another about the roof opening.

20. The method as recited in claim 18, wherein:
the step of moving the panel to the first open position includes moving a first portion of the panel relative to a beam projecting across the roof opening, and
the step of moving the panel to the second open position includes moving a second portion of the panel relative to the beam.
